(19) United States
(12) Patent Application Publication
(10) Pub. No.: US 2014/0369528 A1
(43) Pub. Date: Dec. 18, 2014

(54) MIXING DECISION CONTROLLING DECODE DECISION

(71) Applicant: Lars Henrik ELLNER, San Francisco, CA (US)

(72) Inventor: Lars Henrik ELLNER, San Francisco, CA (US)

(73) Assignee: GOOGLE INC.

(21) Appl. No.: 13/348,278

(22) Filed: Jan. 11, 2012

(51) Int. Cl. H04B 1/00

(52) U.S. Cl. 381/119

(57) ABSTRACT

Methods, systems, and apparatus are provided for combining (e.g., mixing) audio signals received from a plurality of participants communicating with each other during a communication session (e.g., an audio conference) based on voice-activity-detection (VAD) data contained in extended headers of Real-time Transport Protocol (RTP) packets. An audio mixing apparatus receives RTP packets from connected clients and extracts the VAD data included in the extended RTP headers to render a mixing decision. Once a mixing decision has been made, the audio frames to be mixed are decoded while other received frames are discarded, thereby preventing processing resources from being wasted to decode frames that are never used.

### FIELD OF THE INVENTION

The present disclosure generally relates to methods, systems, and apparatus for mixing audio signals. More specifically, aspects of the present disclosure relate to an audio mixing apparatus mixing incoming audio signals based on voice-activity-detection data received with the incoming audio signals.

### BACKGROUND

In audio conferencing systems designed to handle communications involving multiple participants, an audio mixer receives audio streams from most or all of the conference participants and selectively mixes some of the received streams for forwarding to other participants. Depending on the size of the conference, the audio mixer can receive a large number of incoming audio streams at the same time. Because there is usually only a need to mix a subset of these incoming streams, a substantial number of processing resources are often wasted decoding audio frames that will never be used.

One approach uses voice-activity-detection (VAD) to determine which audio conference participants to mix. However, VAD is performed in the signal domain, and therefore a frame of an incoming audio stream for a particular participant must be decoded in order to determine if the frame contains voice data. As such, under this approach a decision regarding whether or not a frame should be included in a mix requires that the frame be decoded, and thus resources are expended regardless. This expenditure of resources potentially imposes limits on the size and/or number of audio conferences that a given audio mixer can support.

Another approach relates to using an extended Real-time Transport Protocol (RTP) header to determine which participants in an audio conference should be relayed to other participants, where the RTP header extension contains a VAD decision provided by each of the (far-end) participants connected to the relay server. This approach proposes using such a RTP header extension to render relay decisions, where the server does not perform any audio mixing.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a method for mixing audio signals comprising: receiving, at an audio mixing apparatus, audio packets from a plurality of clients in communication with the audio mixing apparatus; retrieving audio level data contained in an extended packet header of each of the received audio packets; selecting audio frames to be mixed based on the audio level data retrieved from the extended packet headers of the audio packets; decoding the audio frames selected to be mixed; and generating a mixed audio stream by mixing the decoded audio frames.

In another embodiment of the disclosure, the method for mixing audio signals further comprises, in response to receiving the audio packets from the plurality of clients, determining, for each audio frame contained in the audio packets, whether audio level data can be extracted from the audio frame without decoding the audio frame.

In another embodiment of the disclosure, the method for mixing audio signals further comprises: in response to determining that audio level data can be extracted from the audio frame without decoding the audio frame, extracting audio level data from the audio frame; storing the audio level data extracted from the audio frame in an audio level data set; and storing the audio frame in an encoded audio frames set.

In yet another embodiment of the disclosure, the method for mixing audio signals further comprises: in response to determining that no audio level data can be extracted from the audio frame without decoding the audio frame, decoding the audio frame; performing audio level processing on the decoded audio frame to obtain audio level data for the decoded audio frame; storing the audio level data obtained for the decoded audio frame in the audio level data set; and storing the decoded audio frame in a decoded audio frames set.

In still another embodiment of the disclosure, the method for mixing audio signals further comprises: selecting a group of encoded audio frames from the encoded audio frames set and a group of decoded audio frames from the decoded audio frames set; retrieving, from the audio level data set, the audio level data stored for the group of encoded audio frames and the group of decoded audio frames; applying a mixing decision algorithm based on the audio level data retrieved from the audio level data set; and determining a set of encoded and decoded audio frames to be mixed based on the applied mixing decision algorithm.

In another embodiment of the disclosure, the method for mixing audio signals further comprises storing the received audio packets in a buffer of the audio mixing apparatus.

In another embodiment of the disclosure, the method for mixing audio signals further comprises discarding the audio frames not selected to be mixed.

Another embodiment of the disclosure relates to an audio mixing apparatus configured to perform operations comprising: receiving audio packets from a plurality of clients in communication with the audio mixing apparatus; retrieving audio level data contained in an extended packet header of each of the received audio packets; selecting audio frames to be mixed based on the audio level data retrieved from the extended packet headers of the audio packets; decoding the audio frames selected to be mixed; and generating a mixed audio stream by mixing the decoded audio frames.

In another embodiment of the disclosure, the audio mixing apparatus is further configured to perform operations comprising, in response to receiving the audio packets from the plurality of clients, determining, for each audio frame contained in the audio packets, whether audio level data can be extracted from the audio frame without decoding the audio frame.

In yet another embodiment of the disclosure, the audio mixing apparatus is further configured to perform operations comprising: in response to determining that audio level data can be extracted from the audio frame without decoding the audio frame, extracting audio level data from the audio frame; storing the audio level data extracted from the audio frame in an audio level data set; and storing the audio frame in an encoded audio frames set.

In still another embodiment of the disclosure, the audio mixing apparatus is further configured to perform operations comprising: in response to determining that no audio level data can be extracted from the audio frame without decoding the audio frame, decoding the audio frame; performing audio level processing on the decoded audio frame to obtain audio level data for the decoded audio frame; storing the audio level data obtained for the decoded audio frame in the audio level data set; and storing the decoded audio frame in a decoded audio frames set.

In another embodiment of the disclosure, the audio mixing apparatus is further configured to perform operations comprising: selecting a group of encoded audio frames from the encoded audio frames set and a group of decoded audio frames from the decoded audio frames set; retrieving, from the audio level data set, the audio level data stored for the group of encoded audio frames and the group of decoded audio frames; applying a mixing decision algorithm based on the audio level data retrieved from the audio level data set; and determining a set of encoded and decoded audio frames to be mixed based on the applied mixing decision algorithm.

In still another embodiment of the disclosure, the audio mixing apparatus is further configured to perform operations comprising storing the received audio packets in a buffer of the audio mixing apparatus.

In another embodiment of the disclosure, the audio mixing apparatus is further configured to perform operations comprising discarding the audio frames not selected to be mixed.

In other embodiments of the disclosure, the methods and apparatuses described herein may optionally include one or more of the following additional features: the audio packets received from the plurality of clients are Real-Time Transport Protocol (RTP) packets, and/or the audio level data contained in the extended packet header of each of the received audio packets includes voice data corresponding to one of the plurality of clients.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example audio mixing environment in which various embodiments of the present disclosure may be implemented.

FIG. 2 is a block diagram illustrating an example audio mixing apparatus along with incoming and outgoing data flows according to one or more embodiments described herein.

FIG. 3 is a flowchart illustrating an example method for receiving and storing a voice-activity-detection decision from a client participating in an audio conferencing session according to one or more embodiments described herein.

FIG. 4 is a flowchart illustrating an example method for rendering a mixing decision based on available voice-activity detection decisions received from clients participating in an audio conferencing session according to one or more embodiments described herein.

FIG. 5 is a block diagram illustrating an example computing device arranged for rendering an audio mixing decision according to one or more embodiments described herein.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

Embodiments of the present disclosure relate to methods, systems, and apparatus for combining (e.g., mixing) audio signals received from a plurality of participants communicating with each other during a communication session (e.g., an audio conference) based on voice-activity-detection (VAD) data contained in the received signals. In at least some arrangements, participants (e.g., users, clients, individuals, etc.) in an audio conference communicate by sending Real-Time Transport Protocol (RTP) packets containing audio data (e.g., voice data) to an audio mixing apparatus (sometimes referred to herein as an “audio mixer” or simply a “mixer” for purposes of brevity).

One or more embodiments relate to determining audio signals to be included in an audio mixing decision based on VAD data contained in an extended profile of received data packets containing the audio signals. In at least one implementation, a number of participants (e.g., all, none, or any number of participants) in an audio conference may send outgoing audio signals (e.g., audio streams) to an audio mixer (e.g., a server) as RTP packets with an extended RTP-profile (sometimes also referred to herein as “RTP header extension” or “extended RTP header”). The participants can use the extended RTP-profile of the outgoing audio data packets to indicate an audio level (e.g., VAD data) of the packets' payload. Among other advantages, this approach reduces the processing load for the audio mixer since the audio mixer does not need to decode audio streams that are not going to be included in a mixed audio stream. Once a mixing decision has been rendered, received audio streams that should be mixed can be decoded by the audio mixer while other received audio streams can be discarded.

In at least one embodiment, an audio mixer being used in an audio conference receives RTP packets containing audio data sent to the mixer from clients participating in the conference. The audio mixer stores the received RTP packets in a buffer. As will be described in greater detail below, the audio mixer may retrieve (e.g., extract, receive, determine, etc.) a VAD decision (e.g., VAD data) from the extended RTP header of the received packets.

In one embodiment, if a client is not using the extended RTP header (e.g., audio from the client is not being transmitted in RTP packets configured with the extended header as described herein), then the audio mixer may decode the frames belonging to that client's audio stream, perform VAD processing on the decoded frames, and store the decoded frames and the VAD decision (e.g., in a decoded frames set and a VAD decision set, respectively, both of which will be described in greater detail below). In another embodiment, if a Discontinuous Transmission (DTX) frame is received for one stream from a particular client, then the audio mixer may set the VAD decision to, for example, “not voice” and then store the received frame.

Additionally, if no frame is received at the audio mixer for one stream from a client, then, in accordance with at least some embodiments, the audio mixer may approximate a VAD decision for that client. For example, the audio mixer may use the client's previous VAD decision to approximate a VAD decision for the instance in which no frame was received. In one embodiment, the previous VAD decision may be used for some consecutive amount of frames and the subsequent VAD decisions determined as “not voice” until a frame is received again. In still another embodiment, the VAD decision may be set to “not voice” as soon as no frame is received during the mixing window. In any such embodiments, the process (e.g., the audio mixer) stores the VAD decision in a set of VAD decisions, as further described herein.

In one or more embodiments, determining whether or not a particular audio stream should be considered in a mixing decision (e.g., the decision as to which incoming client audio signals to mix or combine into a mixed audio signal sent to clients in a given mix cycle) may partially depend on an analysis of signal energy present in the frame. For example, in at least one implementation where the signal energy of a frame is analyzed or measured, the mixing decision would involve only mixing a specific number of participants with the highest signal energy in their respective audio frames.

Furthermore, in at least one embodiment of the disclosure a variation of the RTP profile extension described herein may be used to provide a VAD decision rendered at the client to an audio mixing apparatus for purposes of making a mixing decision. An example includes signaling the VAD decision in the payload header of the applicable audio codec involved. In another embodiment, an audio codec may be designed such that the VAD of a given audio frame can be detected with significantly less processing resources (e.g., CPU cycles) than is required to fully decode the frame. Additionally, one or more other embodiments relate to signaling VAD decisions for audio frames to the audio mixer in a separate stream (e.g., out of band signaling).

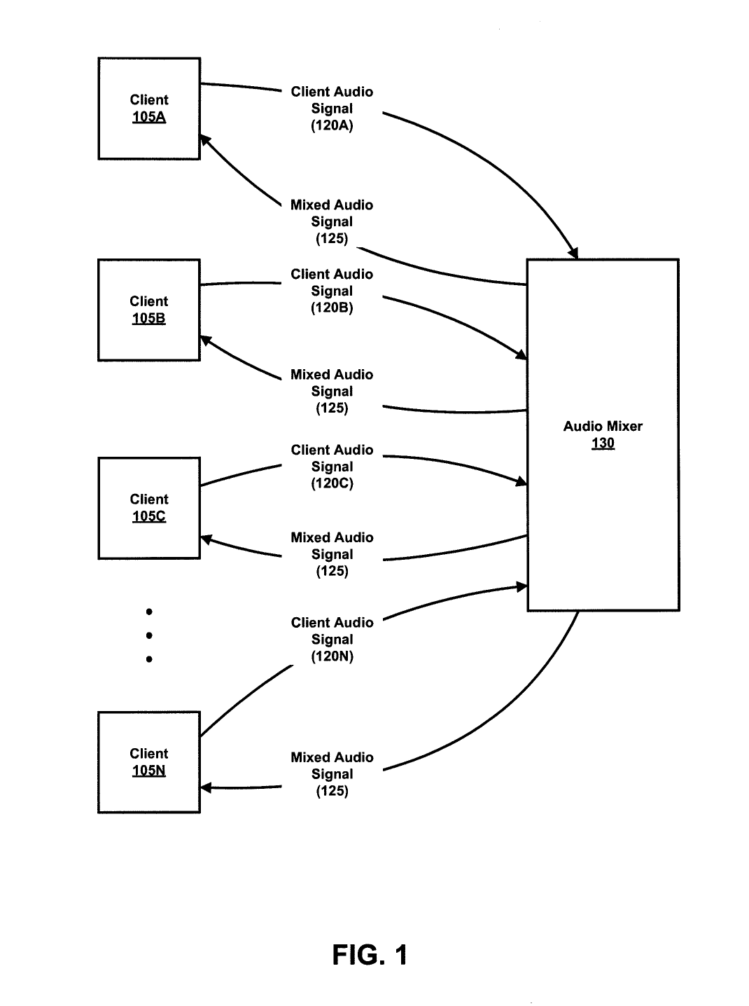

FIG. 1 illustrates an example audio mixing environment in which various embodiments of the present disclosure may be implemented. As shown in the example environment of FIG. 1, an audio mixer 130 receives from clients 105A, 105B, 105C through 105N (where “N” is an arbitrary number) client audio signals 120A, 120B, 120C through 120N, respectively. In turn, the audio mixer 130 sends to each of the clients 105A, 105B, 105C through 105N a mixed audio signal 125 which, as will be described in greater detail herein, may be comprised of a subset of the incoming client audio signals 120A, 120B, 120C through 120N.

In at least one scenario, the clients 105A, 105B, 105C through 105N are participants (e.g., users, individuals, etc.) in a communication session (e.g., audio conference, audio conferencing session, etc.), where the clients 105A, 105B, 105C through 105N are communicating with each other by sending and receiving audio signals via the audio mixer 130. For example, in a given mix cycle (e.g., mix session, mix period, etc.) of an audio conferencing session, the audio mixer 130 may receive incoming audio signals from some or all of the clients 105A, 105B, 105C through 105N participating in the session. However, the audio mixer 130 may only mix (e.g., combine) a select subset of such incoming audio signals (e.g., client audio signals 120A, 120B, 120C through 120N) to send back to the clients 105A, 105B, 105C through 105N in the form of the mixed audio signal 125. As will be described in further detail below, the decision (sometimes be referred to herein as the “mixing decision”) as to which of the incoming client audio signals 120A, 120B, 120C through 120N should be included in the mixed audio signal 125 depends on one or more of a variety of factors, considerations, and criteria.

Furthermore, it should be noted that the mixed audio signal 125 sent to each of the clients 105A, 105B, 105C through 105N may vary between the clients, depending on whether or not a particular client's own audio (e.g., client audio signals 120A, 120B, 120C through 120N) was included in the mixed audio generated by the audio mixer 130. For example, if client audio signal 120B was mixed as a result of a mixing algorithm applied by the audio mixer 130, but client audio signal 120A was not mixed, then the mixed audio signal 125 sent to client 105A will be different from the mixed audio signal sent to client 105B. In such a scenario, the mixed audio signal 125 sent to client 105A will contain the mixed audio of all the clients whose audio was included in the mix, while the mixed audio signal 125 sent to client 105B will be similar but with client 105B's own audio filtered out (e.g., since the client does not want to hear his or her own audio).

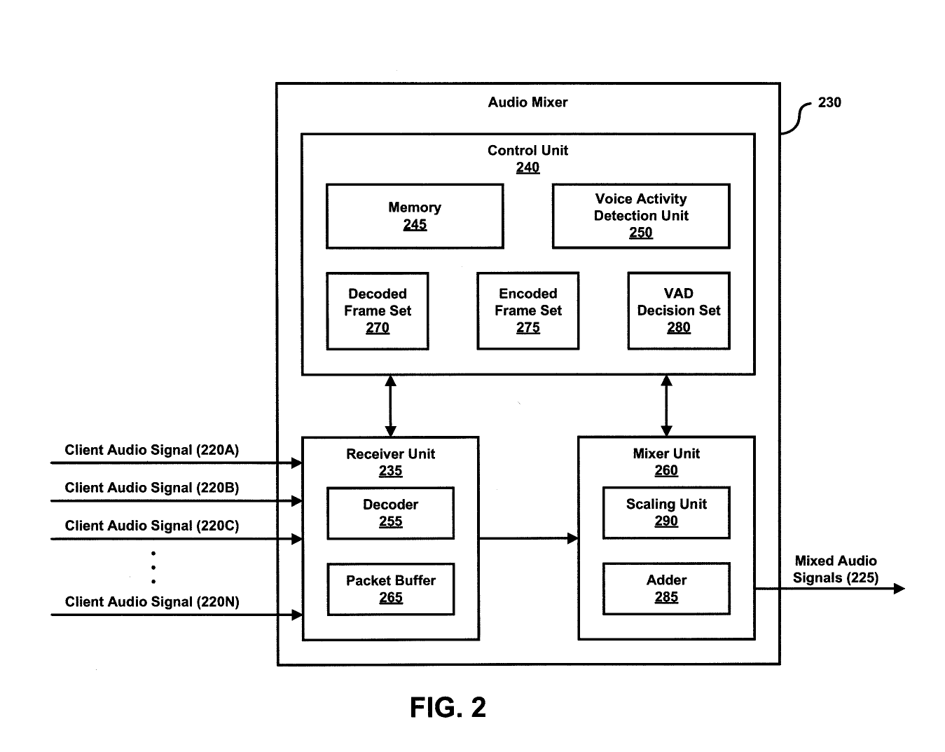

FIG. 2 illustrates an example audio mixing apparatus along with incoming and outgoing data flows according to at least some embodiments of the present disclosure. The example audio mixer 230 shown includes a mixer control unit 240, a mixer unit 260, and a receiver unit 235.

In one or more embodiments, the receiver unit 235 includes a decoder 255 and a packet buffer 265. A set of client audio signals 220A, 220B, 220C, through 220N (where “N” is an arbitrary number) may be received at the receiver unit 235 and processed by the decoder 255. The client audio signals 220A, 220B, 220C, through 220N may be received at the audio mixer 230 and, more specifically, at the receiver unit 235, from one or more audio channels that provide the client audio signals 220A, 220B, 220C, through 220N as audio packets containing segments of the audio signals. For example, the client audio signals 220A, 220B, 220C, through 220N may be RTP packets containing data corresponding to segments of audio signals (e.g., generated by clients 105A through 105N as shown in FIG. 1). In accordance with various embodiments of the disclosure, such RTP packets comprising the incoming client audio signals 220A, 220B, 220C, through 220N may have extended RTP headers containing VAD data. Additionally, the audio mixer 230 produces as output, one or more mixed audio signals 225. The mixed audio signals 225 may be generated as a result of a mixing algorithm being applied by the audio mixer 230.

In at least the example embodiment shown in FIG. 1, the control unit 240 includes a memory 245, a decoded frame set 270, an encoded frame set 275, and a VAD decision set 280. Depending on the implementation, the mixer control unit 240 also includes, or is operably connected to, a voice activity detection unit 250. The voice activity detection unit 250 may be configured to perform a variety of operations on audio frames received at the audio mixer 230 from the client audio signals 220A, 220B, 220C, through 220N. For example, where an audio frame received at the audio mixer 230 does not include an extended RTP header (which is described in greater detail herein), the audio frame may be decoded by the decoder unit 255 before being sent to the voice activity detection unit 250 for voice-activity-detection (VAD) processing.

In some embodiments, one or more of the Decoded Frame Set 270, the Encoded Frame Set 275, and the VAD Decision Set 280 may be designated portions of a physical memory of the audio mixer 230, buffers implemented in a physical memory of the audio mixer 230, or may be stored in such designated portions or buffers, or may be any combination of the same. Additionally, because the Decoded Frame Set 270 and the Encoded Frame Set 275 may store decoded and encoded frames, respectively, while the VAD Decision Set 280 stores data related to voice activity, the Decoded Frame Set 270 and the Encoded Frame Set 275 may be contained in a memory type different than a memory type containing the VAD Decision Set 280. It should be understood that numerous other types and variations of memory, databases, and data storage spaces may also be configured for use as the Decoded Frame Set 270, the Encoded Frame Set 275, and/or the VAD Decision Set 280 in addition to or instead of the examples described above.

In one or more embodiments, the audio mixer 230 may also include other audio mixing components in addition to or instead of the example components illustrated in FIG. 2. Such other components may similarly be designed or configured to be capable of combining (e.g., mixing) audio signals received from a plurality of participants communicating with each other during a communication session (e.g., an audio conference) based on an audio mixing algorithm such as the one described herein.

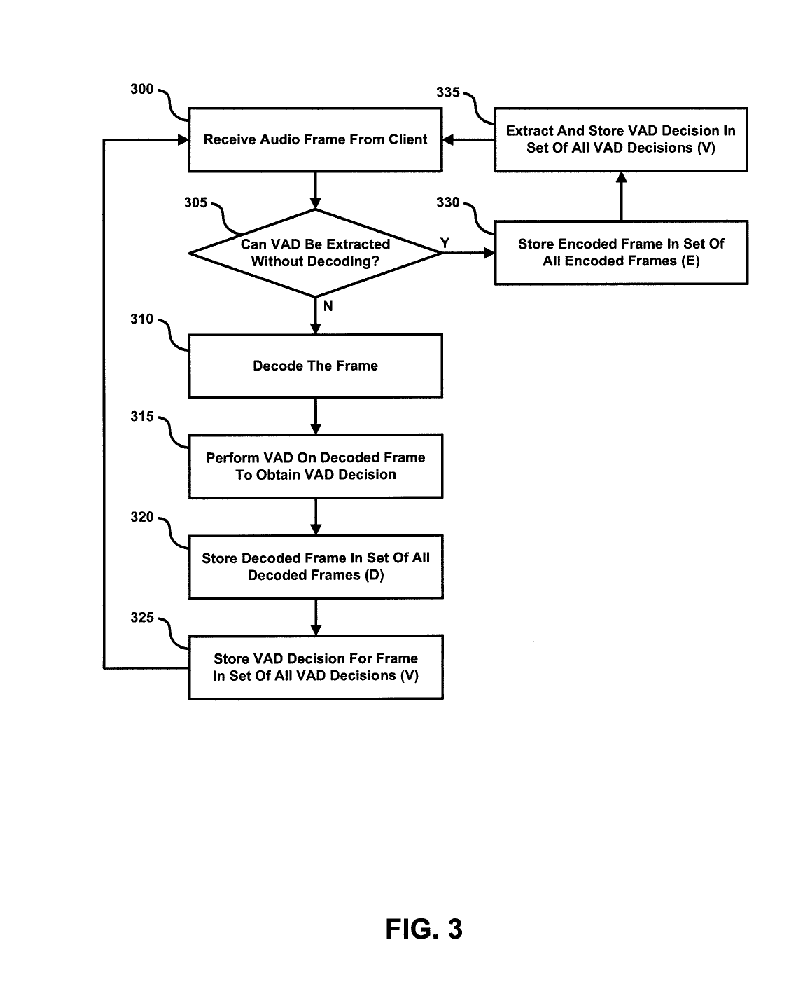

FIG. 3 illustrates an example process for receiving and storing a VAD decision (e.g., VAD data) from a client participating in an audio conference. In at least some embodiments of the present disclosure, the example process illustrated in FIG. 3 and described in greater detail below may be performed by an audio mixing apparatus or conferencing server (e.g., audio mixer 130 as shown in FIG. 1). In one example scenario, the process may be performed by the audio mixing apparatus during an audio conferencing session in which a number of clients (e.g., clients 105A, 105B, 105C through 105N as shown in FIG. 1) participating in the session are sending audio streams to the mixing apparatus in the form of RTP packets containing encoded audio frames (e.g., audio data generated and encoded by, for example, microphones or other audio capture devices being used by the participating clients).

The process begins in step 300 where an audio frame is received (e.g., at an audio mixer) from a client during a given mix period (e.g., mix cycle, mixing window, etc.). In at least some embodiments, the audio frame received at step 300 is an encoded frame contained in an RTP packet, and may be contained in the RTP packet along with one or more additional encoded audio frames. For example, the audio frame received may be contained in one of a plurality of RTP packets transmitted from clients and received at an audio mixer during the particular mix period. Depending on the implementation, the RTP packets received from the clients may be stored in a buffer of the audio mixer (e.g., packet buffer 265 of audio mixer 230 as shown in FIG. 2).

Once the audio frame is received in step 300, a determination is made in step 305 as to whether a VAD decision (e.g., VAD data indicating an audio level of the received frame) can be extracted without decoding the frame. In accordance with various embodiments of the disclosure, clients participating in the audio conference send audio data to the audio conference server as RTP packets with an extended RTP header in which the clients can indicate an audio level (e.g., a VAD decision) of the packets' payload. In other words, the RTP header extension carries the VAD decision of the audio contained in the RTP payload of the packet to which the header extension corresponds. Accordingly, in at least one embodiment, the determination made in step 305 may include determining whether the audio frame was received from a client using the extended RTP header. If so, then the VAD decision can be extracted from the extended RTP header without decoding the frame and the process moves to step 330 where the encoded frame is stored.

In one embodiment, the determination made in step 305 about whether a VAD decision (e.g., VAD data indicating an audio level of the received frame) can be extracted without decoding the frame may be performed by a receiver unit of the audio mixer (e.g., receiver unit 235 as shown in FIG. 2), or by some other component or element of the audio mixer. Depending on the particular audio mixer used, such a receiver unit may be designed or configured in a manner such that it is capable of determining whether or not a given packet is received with an extended header attribute indicating that the packet includes a RTP header extension as described above. In another embodiment, one or more other components of the audio mixer may be responsible for determining whether or not a VAD decision can be extracted from a received frame without decoding the frame in addition to or instead of a receiver unit of the audio mixer as described above. Furthermore, numerous other approaches may be used to render such a determination in addition to or instead of by way of examining a received packet for an extended header attribute.

In step 330, the encoded frame may be stored (e.g., by a mixer control unit, such as mixer control unit 240 of the example audio mixer 230 as shown in FIG. 2) in a set of all encoded frames which, at least in the example process shown in FIG. 3 may be represented as “E”. In one implementation, the set of all encoded frames, E, may correspond to the encoded frame set 275 of the example audio mixer 230 shown in FIG. 2.

Following step 330, the process continues to step 335 where the VAD decision (which was determined to be extractable without decoding the frame in step 305) is extracted from the encoded audio frame and stored in a set of all VAD decisions, represented as “V” in the example process shown. Similar to the set of all encoded frames, E, the set of all VAD decisions, V, may correspond to the VAD decision set 280 of the example audio mixer 230 illustrated in FIG. 2. After the VAD decision has been extracted and stored in step 335, the process moves to step 300 and repeats for the next received audio frame.

In step 305, if it is instead determined that a VAD decision cannot be extracted without decoding the received audio frame, then the process goes to step 310 where the audio frame is decoded. The audio frame may be decoded in step 310 using any state of the art decoder (e.g., decoder 255 of the example audio mixer 230 shown in FIG. 2) suitable for the purpose, as will be appreciated by those skilled in the art.

After the received audio frame is decoded in step 310, voice-activity-detection (VAD) is performed on the decoded frame in step 315. In at least some embodiments, VAD may be performed on the decoded frame by a voice detection unit contained in, or operably connected to, the audio mixer (e.g., voice detection unit 250 of audio mixer 230 as shown in FIG. 2). In any of the various embodiments described herein, the detection of audio activity (e.g., voice activity, which can indicate a presence or absence of speech based on the particular level of activity detected or measured) can be performed in a number of different ways. For example, the VAD in step 315 can be based on one or more energy criteria indicating that an audio (e.g., voice) activity level in the decoded frame is above a particular background noise level. Additionally, the detection of voice activity in step 315 of the process may be performed by some other entity or component within, or connected to, the audio mixing apparatus.

Furthermore, in at least some embodiments the VAD described in connection with step 315 may be based on information received along with the audio frame. For example, there may be a scenario where although a VAD decision cannot be extracted from the audio frame in step 305 without first decoding the frame in step 310, the determination of voice activity in step 315 may still be based on data generated as a result of processing that occurred remotely from the audio mixer (e.g., at the audio source, such as the client). It should be noted that in any of the various embodiments of the present disclosure, detecting voice activity in a received audio frame may be performed in accordance with the VAD procedure described in granted U.S. Pat. No. 6,993,481.

The process continues to step 320 where the decoded frame is stored in a set of all decoded frames, which is represented as “D” in at least the example process illustrated in FIG. 3. Similar to the set of all encoded frames, E, the set of all decoded frames, D, may correspond to the Decoded Frame Set 270 of the example audio mixer 230 illustrated in FIG. 2.

In step 325, the VAD decision obtained for the decoded frame in step 315 is stored in the set of all VAD decisions, V, as described above with respect to step 335. Once the VAD decision is stored in V, the process returns to step 300 and repeats for the next audio frame received.

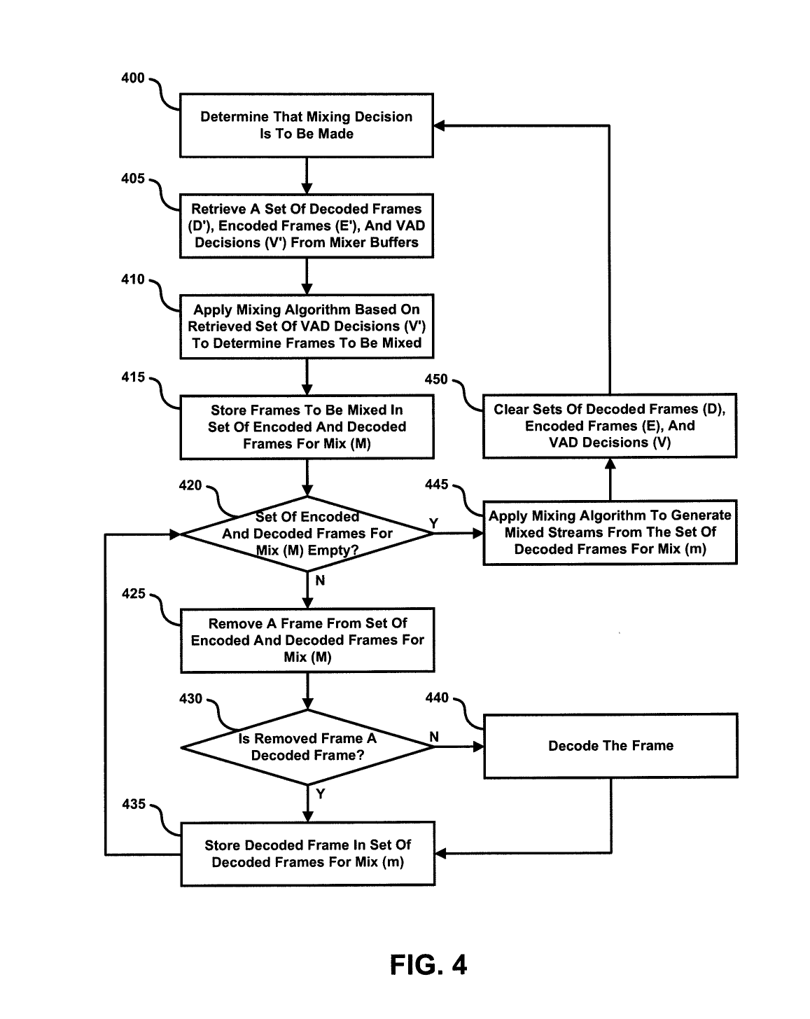

FIG. 4 illustrates an example process for rendering a mixing decision based on available VAD decisions received from clients participating in an audio conference. As with the example process illustrated in FIG. 3, in at least some embodiments of the present disclosure, the example process illustrated in FIG. 4 and described in greater detail below may be performed by an audio mixing apparatus (e.g., conferencing server, such as audio mixer 130 as shown in FIG. 1).

In one scenario, the process may be performed by the audio mixing apparatus during an audio conferencing session in which a number of clients (e.g., clients 105A, 105B, 105C through 105N as shown in FIG. 1) participating in the session are sending audio streams to the mixing apparatus in the form of RTP packets. For example, the process may be performed by the audio mixing apparatus following the receipt of such packets from clients and the storage of encoded frames, decoded frames, and VAD decisions, as described above with respect to FIG. 3. The example process shown includes steps that may be performed during a particular mix cycle (e.g., mix period, mix instance, etc.) of many mix cycles that collectively comprise an audio conferencing session involving multiple participants.

The process begins at step 400 where it is determined that a mixing decision is to be made. For example, as described above with respect to the process illustrated in FIG. 3, a determination that a mixing decision is to be made may occur following the receipt of audio data packets at an audio mixer (e.g., audio mixer 130 shown in FIG. 1) from participating clients, and following the processing and storage of encoded frames, decoded frames, and VAD decisions obtained by the audio mixer from those data packets. In at least one embodiment, the frames and/or VAD decisions are stored in one or more buffers of the audio mixer (e.g., decoded frame set 270, encoded frame set 275, and VAD decision set 280 as shown in FIG. 2).

In step 405, a set (e.g., subset) of decoded audio frames, a set (e.g., subset) of encoded audio frames, and a set (e.g., subset) of VAD decisions corresponding to each of the decoded and encoded sets are retrieved from one or more buffers of the audio mixer, where for purposes of the present description the set of decoded audio frames is represented as D′, the set of encoded audio frames is represented as E′, and the set of VAD decisions is represented as V′. In one embodiment, D′ may be retrieved from a set of all decoded frames, E′ may be retrieved from a set of all encoded frames, and V′ may be retrieved from a set of all VAD decisions (e.g., the set of all decoded frames D, the set of all encoded frames E, and the set of all VAD decisions V as shown in FIG. 3). With reference to example audio mixer shown in FIG. 2, in at least one implementation one or more of D′, E′, and V′ may be retrieved from the decoded frame set 270, encoded frame set 275, and VAD decision set 280, respectively.

The process then goes to step 410 where a mixing decision algorithm (which is sometimes referred to herein simply as a “mixing decision”) may be applied based on the set of VAD decisions V′ retrieved in step 405. In at least one embodiment, the mixing decision algorithm is applied in order to determine which of the audio frames in D′ and/or E′ are to be included in the mixing operation for the given mix cycle. A number of different mixing decision algorithms may be used in step 410. For example, in one embodiment the mixing decision could be to mix all, or a subset of all, clients that have sent audio streams from which a positive VAD decision has been extracted or for which a positive VAD decision has been rendered.

In another embodiment, the mixing decision rendered in step 410 may partially depend on an analysis of signal energy present in the audio frames comprising D′ and E′. For example, in an implementation where the signal energy of a frame is analyzed and/or measured, the mixing decision may involve only mixing a specific number of participants with the highest signal energy in their respective audio frames. It should be understood by those skilled in the art that a variety of other mixing decision algorithms may also be applied in step 410 of the process illustrated in FIG. 4 in addition to or instead of the example algorithms described above.

The process continues to step 415 where the audio frames to be mixed, based on the mixing decision made in step 410, are stored in a set of encoded and decoded frames for mix (which for purposes of the present description is represented as M). Additionally, in at least some embodiments, any audio frames that are not stored as part of M may be discarded following step 415.

In step 420, a determination is made as to whether the set of encoded and decoded frames for mix, M, is empty (e.g., whether M contains any remaining audio frames to be included in the mixing operation for the present mix cycle). If it is determined in step 420 that M is not empty, then in step 425 an audio frame is removed from M After an audio frame is removed from M in step 425, it is determined in step 430 whether or not the removed audio frame is a decoded audio frame (e.g., a frame from the set of decoded frames D′).

If it is found in step 430 that the audio frame removed from M is a decoded audio frame, then in step 435 the decoded audio frame is stored in a set of decoded frames for mix, represented as m for purposes of the present description. On the other hand, if in step 430 it is determined that the audio frame removed from M is not a decoded frame (e.g., the audio frame removed from M is an encoded audio frame from the set of encoded audio frames E′) then the process goes to step 440 where the audio frame is decoded. Once the audio frame is decoded in step 440, the decoded audio frame is stored in the set of decoded frames for mix, m, in step 435.

After step 435, the process returns to step 420 where it is again determined whether the set of encoded and decoded frames for mix, M, is empty. If M is not empty, then steps 425 through 435 are repeated for an audio frame that remains in M. However, if in step 420 it is determined that M is empty, the process continues to step 445 where a mixing algorithm is applied to all of the audio frames in m to generate one or more mixed audio streams. In at least one implementation, the mix operation of step 445 may be performed by a mixer unit (e.g., mixer unit 260 of the example audio mixer shown in FIG. 2). It should be noted that the mixing algorithm applied in step 445 of the process is based on the earlier application of the mixing decision algorithm in step 410 of the process, as described above. Stated differently, the mixing algorithm applied in step 410 determines the audio frames to be mixed by application of the mixing algorithm in step 445.

Although not shown as being part of the process in FIG. 4, in accordance with embodiments of the present disclosure, the mix operation performed in step 445 may produce (e.g., generate) as output one or more mixed audio signals (e.g., mixed audio signal 125 as shown in FIG. 1 or mixed audio signals 225 as shown in FIG. 2). The one or more mixed audio signals generated from mixing all of the frames included in the set of decoded frames for mix, m, may be sent from an audio mixer to the clients participating in the audio conference (e.g., clients 105A through 105N as shown in FIG. 1).

Following the mix operation performed in step 445, the process goes to step 450 where the set of all decoded frames D, the set of all encoded frames E, and the set of all VAD decisions V (as described above with respect to the process shown in FIG. 3) are cleared for the start of the next mix cycle in step 400.

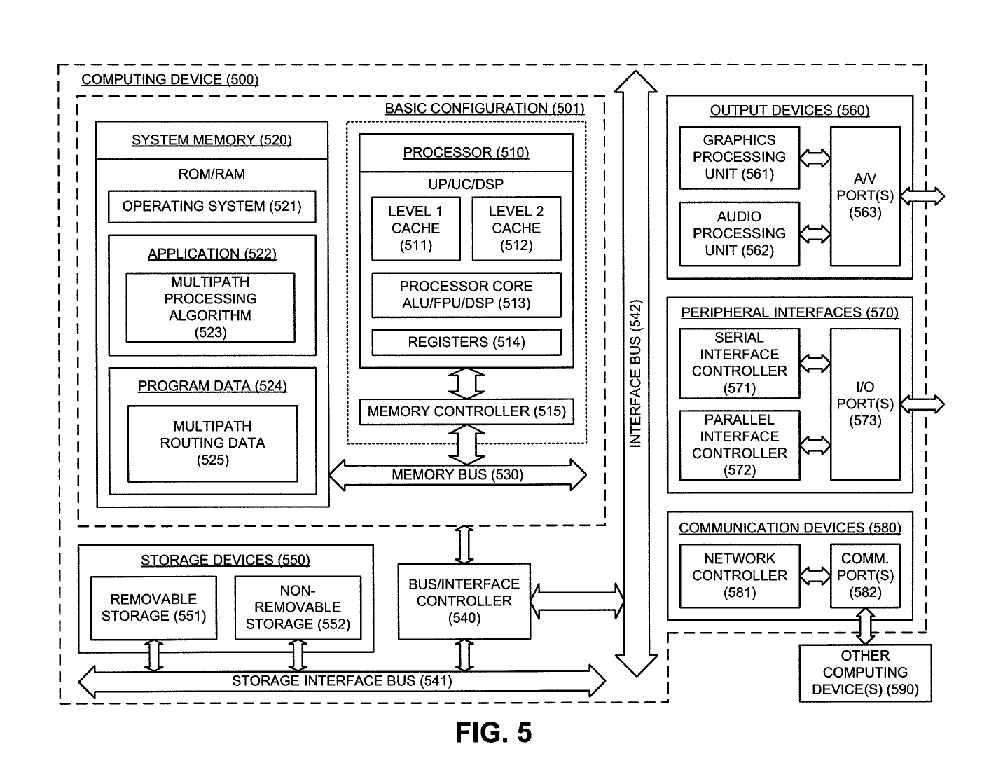

FIG. 5 is a block diagram illustrating an example computing device 500 that is arranged for determining a mixing decision to combine (e.g., mix) audio signals received from a plurality of communicating users based on voice-activity-detection (VAD) data contained in the received signals in accordance with one or more embodiments of the present disclosure. In a very basic configuration 501, computing device 500 typically includes one or more processors 510 and system memory 520. A memory bus 530 may be used for communicating between the processor 510 and the system memory 520.

Depending on the desired configuration, processor 510 can be of any type including but not limited to a microprocessor (μP), a microcontroller (μC), a digital signal processor (DSP), or any combination thereof. Processor 510 may include one or more levels of caching, such as a level one cache 511 and a level two cache 512, a processor core 513, and registers 514. The processor core 513 may include an arithmetic logic unit (ALU), a floating point unit (FPU), a digital signal processing core (DSP Core), or any combination thereof. A memory controller 515 can also be used with the processor 510, or in some embodiments the memory controller 515 can be an internal part of the processor 510.

Depending on the desired configuration, the system memory 520 can be of any type including but not limited to volatile memory (e.g., RAM), non-volatile memory (e.g., ROM, flash memory, etc.) or any combination thereof. System memory 520 typically includes an operating system 521, one or more applications 522, and program data 524. In at least some embodiments, application 522 includes a multipath routing algorithm 523 that is configured to receive and store audio frames based on one or more characteristics of the frames (e.g., encoded, decoded, contain VAD decision, etc.). The multipath routing algorithm is further arranged to identify candidate sets of audio frames for consideration in a mixing decision (e.g., by an audio mixer, such as example audio mixer 230 shown in FIG. 2) and select from among those candidate sets audio frames to include in a mixed audio signal (e.g., mixed audio signal 125 shown in FIG. 1) based on information and data contained in the audio frames (e.g., VAD decisions).

Program Data 524 may include multipath routing data 525 that is useful for identifying received audio frames and categorizing the frames into one or more sets based on specific characteristics (e.g., whether a frame is encoded, decoded, contains a VAD decision, etc.). In some embodiments, application 522 can be arranged to operate with program data 524 on an operating system 521 such that a received audio frame is analyzed to determine its characteristics before being stored in an appropriate set of audio frames (e.g., decoded frame set 270 or encoded frame set 275 as shown in FIG. 2).

Computing device 500 can have additional features and/or functionality, and additional interfaces to facilitate communications between the basic configuration 501 and any required devices and interfaces. For example, a bus/interface controller 540 can be used to facilitate communications between the basic configuration 501 and one or more data storage devices 550 via a storage interface bus 541. The data storage devices 550 can be removable storage devices 551, non-removable storage devices 552, or any combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), tape drives and the like. Example computer storage media can include volatile and nonvolatile, removable and non-removable media implemented in any method or technology for storage of information, such as computer readable instructions, data structures, program modules, and/or other data.

System memory 520, removable storage 551 and non-removable storage 552 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media can be part of computing device 500.

Computing device 500 can also include an interface bus 542 for facilitating communication from various interface devices (e.g., output interfaces, peripheral interfaces, communication interfaces, etc.) to the basic configuration 501 via the bus/interface controller 540. Example output devices 560 include a graphics processing unit 561 and an audio processing unit 562, either or both of which can be configured to communicate to various external devices such as a display or speakers via one or more A/V ports 563. Example peripheral interfaces 570 include a serial interface controller 571 or a parallel interface controller 572, which can be configured to communicate with external devices such as input devices (e.g., keyboard, mouse, pen, voice input device, touch input device, etc.) or other peripheral devices (e.g., printer, scanner, etc.) via one or more I/O ports 573.

An example communication device 580 includes a network controller 581, which can be arranged to facilitate communications with one or more other computing devices 590 over a network communication (not shown) via one or more communication ports 582. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 500 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those skilled within the art that each function and/or operation within such block diagrams, flowcharts, or examples can be implemented, individually and/or collectively, by a wide range of hardware, software, firmware, or virtually any combination thereof.

In one or more embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments described herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Those skilled in the art will further recognize that designing the circuitry and/or writing the code for the software and/or firmware would be well within the skill of one of skilled in the art in light of the present disclosure.

Additionally, those skilled in the art will appreciate that the mechanisms of the subject matter described herein are capable of being distributed as a program product in a variety of forms, and that an illustrative embodiment of the subject matter described herein applies regardless of the particular type of signal-bearing medium used to actually carry out the distribution. Examples of a signal-bearing medium include, but are not limited to, the following: a recordable-type medium such as a floppy disk, a hard disk drive, a Compact Disc (CD), a Digital Video Disk (DVD), a digital tape, a computer memory, etc.; and a transmission-type medium such as a digital and/or an analog communication medium (e.g., a fiber optic cable, a waveguide, a wired communications link, a wireless communication link, etc.).

Those skilled in the art will also recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method for mixing audio signals comprising:
receiving, at an audio mixing apparatus, audio packets from a plurality of clients in communication with the audio mixing apparatus;
retrieving audio level data contained in an extended packet header of each of the received audio packets;
selecting audio frames to be mixed based on the audio level data retrieved from the extended packet headers of the audio packets;
decoding the audio frames selected to be mixed; and
generating a mixed audio stream by mixing the decoded audio frames.

2. The method of claim 1, further comprising:
responsive to receiving the audio packets from the plurality of clients, determining, for each audio frame contained in the audio packets, whether audio level data can be extracted from the audio frame without decoding the audio frame.

3. The method of claim 2, further comprising:
responsive to determining that audio level data can be extracted from the audio frame without decoding the audio frame, extracting audio level data from the audio frame;
storing the audio level data extracted from the audio frame in an audio level data set; and
storing the audio frame in an encoded audio frames set.

4. The method of claim 3, further comprising:
responsive to determining that no audio level data can be extracted from the audio frame without decoding the audio frame, decoding the audio frame;
performing audio level processing on the decoded audio frame to obtain audio level data for the decoded audio frame;
storing the audio level data obtained for the decoded audio frame in the audio level data set; and
storing the decoded audio frame in a decoded audio frames set.

5. The method of claim 4, further comprising:
selecting a group of encoded audio frames from the encoded audio frames set and a group of decoded audio frames from the decoded audio frames set;
retrieving, from the audio level data set, the audio level data stored for the group of encoded audio frames and the group of decoded audio frames;
applying a mixing decision algorithm based on the audio level data retrieved from the audio level data set; and
determining a set of encoded and decoded audio frames to be mixed based on the applied mixing decision algorithm.

6. The method of claim 1, further comprising storing the received audio packets in a buffer of the audio mixing apparatus.

7. The method of claim 1, further comprising discarding the audio frames not selected to be mixed.

8. The method of claim 1, wherein the audio packets received from the plurality of clients are Real-Time Transport Protocol (RTP) packets.

9. The method of claim 1, wherein the audio level data contained in the extended packet header of each of the received audio packets includes voice data corresponding to one of the plurality of clients.

10. An audio mixing apparatus configured to perform operations comprising:
receiving audio packets from a plurality of clients in communication with the audio mixing apparatus;
retrieving audio level data contained in an extended packet header of each of the received audio packets;
selecting audio frames to be mixed based on the audio level data retrieved from the extended packet headers of the audio packets;
decoding the audio frames selected to be mixed; and
generating a mixed audio stream by mixing the decoded audio frames.

11. The audio mixing apparatus of claim 10, further configured to perform operations comprising, responsive to receiving the audio packets from the plurality of clients, determining, for each audio frame contained in the audio packets, whether audio level data can be extracted from the audio frame without decoding the audio frame.

12. The audio mixing apparatus of claim 11, further configured to perform operations comprising:
responsive to determining that audio level data can be extracted from the audio frame without decoding the audio frame, extracting audio level data from the audio frame;
storing the audio level data extracted from the audio frame in an audio level data set; and
storing the audio frame in an encoded audio frames set.

13. The audio mixing apparatus of claim 12, further configured to perform operations comprising:
responsive to determining that no audio level data can be extracted from the audio frame without decoding the audio frame, decoding the audio frame;
performing audio level processing on the decoded audio frame to obtain audio level data for the decoded audio frame;
storing the audio level data obtained for the decoded audio frame in the audio level data set; and
storing the decoded audio frame in a decoded audio frames set.

14. The audio mixing apparatus of claim 13, further configured to perform operations comprising:
selecting a group of encoded audio frames from the encoded audio frames set and a group of decoded audio frames from the decoded audio frames set;
retrieving, from the audio level data set, the audio level data stored for the group of encoded audio frames and the group of decoded audio frames;
applying a mixing decision algorithm based on the audio level data retrieved from the audio level data set; and
determining a set of encoded and decoded audio frames to be mixed based on the applied mixing decision algorithm.

15. The audio mixing apparatus of claim 10, further configured to perform operations comprising storing the received audio packets in a buffer of the audio mixing apparatus.

16. The audio mixing apparatus of claim 10, further configured to perform operations comprising discarding the audio frames not selected to be mixed.

17. The audio mixing apparatus of claim 10, wherein the audio packets received from the plurality of clients are Real-Time Transport Protocol (RTP) packets.

18. The audio mixing apparatus of claim 10, wherein the audio level data contained in the extended packet header of each of the received audio packets includes voice data corresponding to one of the plurality of clients.
